(19) United States
(12) Patent Application Publication
(10) Pub. No.: US 2013/0192536 A1
(43) Pub. Date: Aug. 1, 2013

(54) PET EXERCISE AND TRAINING DEVICE

(71) Applicant: Justin Shane Lohmann, Citra, FL (US)

(72) Inventor: Justin Shane Lohmann, Citra, FL (US)

(21) Appl. No.: 13/363,420

(22) Filed: Feb. 1, 2012

(51) Int. Cl. A01K 15/02; A01K 29/00

(52) U.S. Cl. 119/707; 119/708

(57) ABSTRACT

A pet exercise and training device for exercising and training dogs comprising a rod constructed of a sturdy, yet light weight, class 200 or comparable PVC pipe and a bungee cord tether line preferably covered with a Dacron® polyester sheathing for greater strength, durability and weather resistance, and for preventing whiplash to the dog. The hand held flirt pole of the present invention is especially suitable for exercising and training dogs such as pit bulls and other hyperactive and powerful dogs that require the use of a sturdy and unbreakable flirt pole.

### FIELD OF THE INVENTION

The present invention is generally related to flirt poles for pets. More particularly, the invention relates to hand held flirt poles that are specifically designed to exercise and train pets.

### BACKGROUND OF THE INVENTION

Household pets such as dogs and cats are generally confined indoors and spend a majority of their time sleeping except when let out once or twice a day or taken for an occasional walk as in the case of dogs. This schedule may suit some breeds of dogs and cats while others who are hyperactive by nature such as pit bull dogs for example, need a more vigorous exercise routine to help them expend their excess built up energies and manage their destructive behavior. The importance of exercise for the general well being of these pets has necessitated the need for the development of exercise and play equipment that are sturdier and more resilient than the ones available in the market today.

The use of tethered toys for the amusement and exercise of household pets such as dogs and cats is well known in the art. U.S. Pat. No. 5,111,771 and U.S. Pat. No. 4,948,137 describe tethered lines holding a ball or rubber tube suspended from a mounting bracket, ceiling, or tree limb for the play and exercise of dogs. These, mostly, manmade contraptions, generally referred to as flirt poles restrict the mobility of the animal to the immediate area around the stationary tethered posts or trees with limited interaction between the dog owner and the animal.

The use of hand held flirt poles for pet exercise and play has gained in popularity in recent years. U.S. Pat. No. 4,499,855 describes an entertaining and exercising toy manipulated by a human operator principally for exercising a small animal such as a cat or kitten. U.S. Pat. No. 6,401,665 describes a tethered fetching, training and play device for animals, with a projectile containing an animal treat dangled from one end of a tether and a retractable spring loaded or crank operated reel at the other end. The flirt poles known in the prior art are generally constructed from materials such as wood and metal that are heavy and rigid, plastic which is weak and brittle, and in some cases fiber glass which is found to easily break with even limited use, resulting in potential injury to the pet owner handling the rods as well as injury to the dog or other pet who may inadvertently chew on the rods. In addition, the nylon tether lines popularly used with these flirt poles tend to tangle and cause whiplash to the dog or other pet in the process of pulling on the lines.

Thus there is a need in the prior art for a hand held pet exercise and training flirt pole that is sturdy, durable, and not prone to breakage, providing the owners and their pets a mutually satisfying and pleasant experience when using the flirt pole. The present invention provides such a device.

### SUMMARY OF THE INVENTION

The present invention is a dog exercise and training device in the form of a flirt pole for use by owners of dogs such as pit bulls and other breeds who need daily exercise for their physical and mental well being as well as to maintain the well being of the owner whose busy schedule may not allow for multiple hours of walks per day as prescribed for these breeds by dog behaviorists.

In an exemplary embodiment of the invention, the flirt pole of the invention is comprised of a flexible rod section and a pliable tether line section with a noose knot tied at the end of the line to hold a dog toy or other lure. In this embodiment of the invention, one end of the rod section has a soft vinyl non-slip foam grip for easy gripping along with a wrist strap for additional reinforcement of the hold on the rod while swinging the rod with the tether line in front of the dog or other pet.

In the exemplary embodiment of the invention, the rod section of the flirt pole is constructed of a durable and sturdy, yet light weight material such as a PVC pipe, preferably a class 200 or comparable PVC pipe, and the tether line is made of bungee cord material that withstands the pulling and tugging on the line by heavy dogs such as pit bulls without the line breaking or causing whiplash to the dogs. The flirt pole of the present invention is constructed to weigh less than a pound.

In the exemplary embodiment of the invention, the dog toy or other lure tied to the noose knot at the end of the bungee cord tether line is easily replaced with other toys or lures by loosening the knot and sliding the toy or lure from the knot.

Although the features of the present invention have thus been described in the context of a single embodiment, the features described may also be implemented in other embodiments. In general, the features and embodiments of the invention described in this summary of the invention will become obvious to one skilled in the art when viewed in conjunction with the ensuing brief description of the drawings, detailed description of the invention and the claims that follow.

### BRIEF DESCRIPTION OF THE DRAWINGS

FIG. 1 is a perspective view of the exemplary embodiment of the present invention.

FIG. 2 shows another perspective view of the embodiment of the present invention.

FIG. 3a-3c is an illustration of the use of the flirt pole of the present invention to exercise and train a pet such as a dog.

### DETAILED DESCRIPTION OF THE INVENTION

The present invention is an improvement over prior art flirt pole devices used to exercise and train household pets such as dogs. The flirt pole of the present invention is especially suited for exercising and training dogs such as pit bulls and other dogs who are by nature hyperactive and powerful when lunging and pulling on the tether line holding the toy or lure at the end of the line. The use of sturdy, yet light weight materials like PVC pipe for the rod section of the flirt pole makes the flirt pole more durable compared to flirt poles in the prior art made of easily breakable, wood, plastic and fiberglass rods. A Dacron® polyester or other comparable sheathing over the bungee cord tether line of the present invention also reinforces its durability, strength and weather resistance.

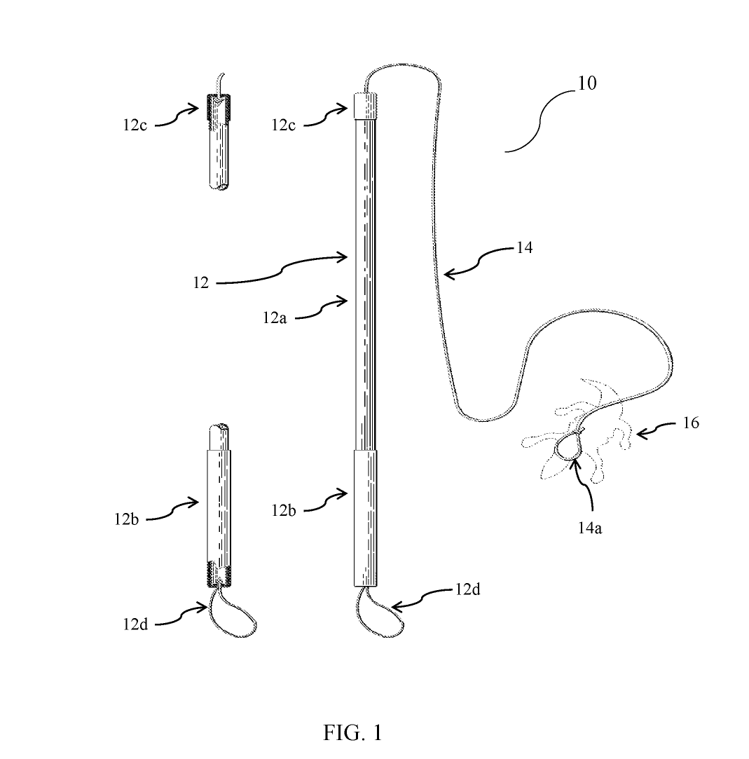

Referring now to the figures, more particularly to FIG. 1, a perspective view of the flirt pole 10 of the present invention is shown. In this embodiment of the invention, the rod 12 section of the flirt pole 10 is preferably 38 inches in length and constructed of an approximately, ¾ inch class 200 or comparable PVC pipe with an outside diameter of approximately 1 inch, which provides the best balance of strength, flexibility, light weight, and safety. The rod 12 is comprised of three sections, the middle section 12a, of the PVC pipe, an approximately 8 inch long closed-cell vinyl foam round grip 12b formed over one end of the PVC pipe section and an approximately, 1.5 inch long pliable vinyl round cap 12c attached to the opposite end of the PVC pipe section. The vinyl foam round grip 12b provides a soft, comfortable, non-slip grip compared to hard plastic or hard rubber grips as used in other flirt poles. The wrist strap 12d is a looped length of approximately ⅜ inch wide nylon webbing extending approximately 6.5 inches from the end of the vinyl foam grip section 12b. The wrist strap 12d is held in place on the end of the vinyl foam grip 12b through a set of washers threaded through the strap inside the vinyl foam grip 12b end of the PVC pipe. The wrist strap 12d helps retain rod 12 in hand and prevents it from flying towards the dog after the animal has got hold of the toy 16 dangling from the noose knot 14a at the end of the tether line 14. In this embodiment of the invention, the tether line 14 attached to the rod 12 section of the flirt pole is comprised of an approximately 60 inch length and approximately ¼ inch diameter bungee cord enclosed within a Dacron® polyester sheathing or other similar material for greater strength, durability and weather resistance. The bungee cord tether line 14 is threaded through the center of the vinyl round cap 12c and knotted behind a metal washer inside the PVC pipe.

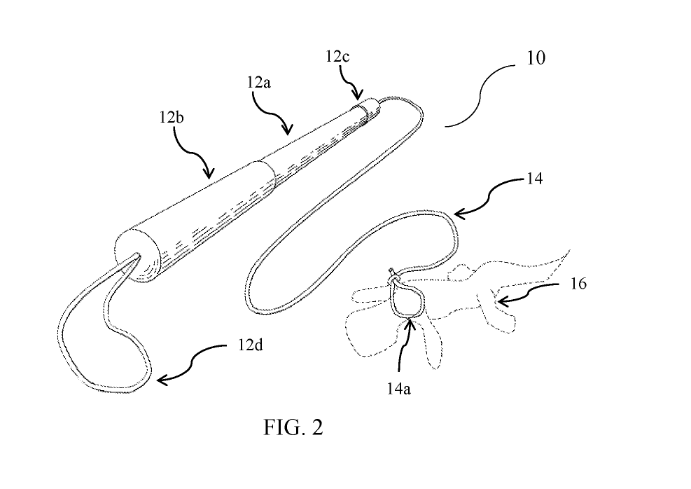

FIG. 2 is a perspective view of the flirt pole 10 of the present invention seen from another angle with a clearer view of the wrist strap 12d held in place on the vinyl foam grip 12b end of the PVC pipe rod 12. This view of the flirt pole 10 also shows the middle section 12a of the PVC pipe rod 12 and the vinyl round cap 12c at the other end of the PVC pipe rod 12, the bungee cord tether line 14, and the noose knot 14a used for holding the toy 16.

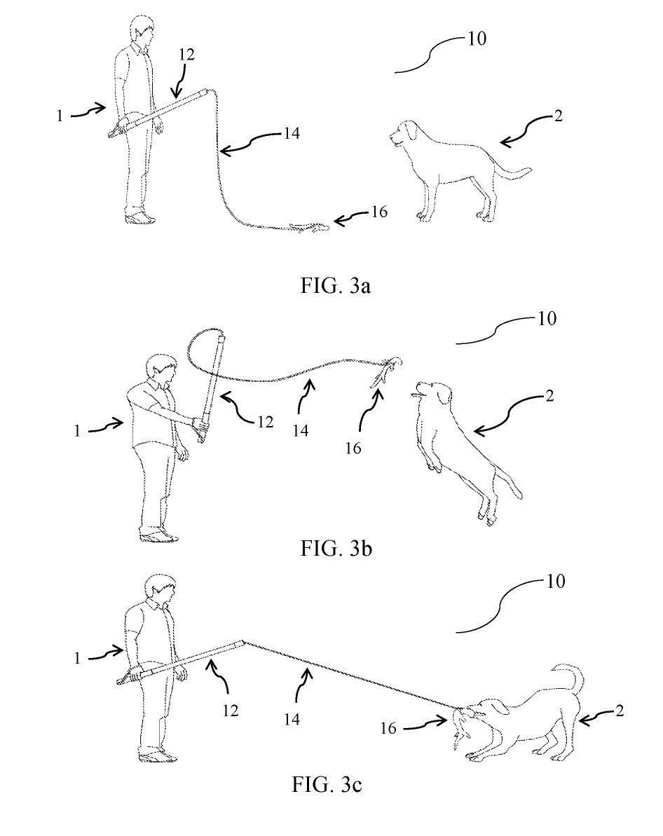

FIG. 3a-3c are illustrations of the use of the flirt pole of the present invention to exercise and train a pet such as a dog. In FIG. 3a, a pet owner or instructor 1 holds the flirt pole 10 of the present invention in one or both hands through the wrist strap and vinyl foam grip on rod 12 and instructs the dog to wait before attempting to grab the toy and/or lure 16 tied to the noose knot at the end of the bungee cord tether line 14. In FIG. 3b the pet owner or instructor 1 swings the rod 12 and the attached bungee cord tether line 14 in any direction and gives the dog 2 the command to begin chasing the toy or lure 16 tied to the end of the tether line 14. The dog 2 then jumps to catch the toy or lure 16 or starts chasing the toy or lure 16 as the owner or instructor 1 flails the tether line 14 in all directions in an attempt to prevent dog 2 from getting hold of the toy or lure 16. When dog 2 eventually catches the toy or lure 16 as shown in FIG. 3c, it is allowed to play with the caught toy or lure 16 for a brief period as a reward and the dog 2 is instructed to release the toy or lure 16 at the end of the reward period. The entire process is repeated until dog 2 is sufficiently exercised for an average period of 10 minutes which is comparable to a one hour walk. Thus the use of the flirt pole of the present invention to exercise dogs saves the owner or instructor valuable time spent walking the dog several times a day or in the case of a pet owner with limited mobility the means to exercise and train their dogs without the need to take the dogs for a walk.

The foregoing description of the present invention through its preferred embodiment and figures should not be construed to limit the scope of the invention. It should be understood and obvious to one skilled in the art that the embodiment of the invention thus described may be further modified without departing from the spirit and scope of the invention as set forth in the claims that follow.

What is claimed is:

1. A pet exercise and training device comprising:
a rod with a first end and a second end;
a tether line with a first end and a second end, the first end of said tether line connected to the second end of said rod;
a round cap attached to the second end of said rod to hold the first end of said tether line;
a grip means configured over the first end of said rod;
a wrist strap means configured at the first end of said rod; and
a noose knot configured at the second end of said tether line to hold a toy or lure.

2. The pet exercise and training device of claim 1 wherein the device is a flirt pole.

3. The pet exercise and training device of claim 1 wherein the rod is constructed from a length of PVC pipe.

4. The pet exercise and training device of claim 1 wherein the tether line is constructed from a length of bungee cord material.

5. The pet exercise and training device of claim 1 wherein the round cap attached to the second end of the rod is constructed from a length of pliable vinyl or similar material.

6. The pet exercise and training device of claim 1 wherein the tether line is threaded through the center of the round cap attached to the second end of the rod and knotted behind a metal washer inside the rod.

7. The pet exercise and training device of claim 1 wherein the grip means is constructed from a length of closed-cell vinyl foam or other soft material for a comfortable and sturdy grip of the rod.

8. The pet exercise and training device of claim 1 wherein the wrist strap means is a looped length of nylon webbing or other similar material and extends approximately 6.5 inches from the end of the grip means at the first end of the rod.

9. The pet exercise and training device of claim 8 wherein the wrist strap means is attached to the first end of the rod through the grip means by a set of inside washers.

10. A method of exercising and training a dog, the method comprising:
holding the rod of the flirt pole by the grip end and wrist strap;
instructing the dog to wait before chasing the toy or lure attached to the noose knot at the end of the tether line;
swinging the flirt pole by the rod in all directions;
giving the dog a command to begin chasing the toy or lure;
rewarding the dog to play with the toy or lure once caught;
instructing the dog to release the lure; and
repeating the process from start to finish until the dog is sufficiently trained and exercised.
